(19) United States
(12) Patent Application Publication
(10) Pub. No.: US 2026/0029744 A1
(43) Pub. Date: Jan. 29, 2026

(54) IMAGE FORMING APPARATUS

(71) Applicant: FUJIFILM Business Innovation Corp., Tokyo (JP)

(72) Inventor: Shuhei YAMAZAKI, Kanagawa (JP)

(73) Assignee: FUJIFILM Business Innovation Corp., Tokyo (JP)

(21) Appl. No.: 19/017,750

(22) Filed: Jan. 12, 2025

(30) Foreign Application Priority Data
Jul. 26, 2024 (JP) 2024-120992

(51) Int. Cl. G03G 21/00; G03G 21/10; G03G 21/12

(52) U.S. Cl. CPC G03G 21/0076; G03G 21/0011; G03G 21/0035; G03G 21/105; G03G 21/12

(57) ABSTRACT

An image forming apparatus includes a cleaning blade that comes into contact with a surface of an image holder and removes toner adhering to the surface of the image holder, an accommodating member that accommodates the toner removed by the cleaning blade, and a supply unit that is disposed in the accommodating member and supplies the toner accommodated in the accommodating member to the surface of the image holder on an upstream side in a rotation direction of the image holder with respect to the cleaning blade.

### CROSS-REFERENCE TO RELATED APPLICATIONS

This application is based on and claims priority under 35 USC 119 from Japanese Patent Application No. 2024-120992 filed Jul. 26, 2024.

### BACKGROUND

### (i) Technical Field

The present invention relates to an image forming apparatus.

### (ii) Related Art

JP2013-182080A discloses a cleaning device including a cleaning blade that abuts on a surface of a photoreceptor drum to remove residual toner from the surface, a screw brush that has a brush part in which brush bristles are tufted and a non-brush part in which the brush bristles are not tufted, the brush part and the non-brush part being spirally provided, and that transports the toner removed from the surface of the photoreceptor drum by the cleaning blade to a toner recovery portion, and a housing that accommodates the cleaning blade and the screw brush, in which the screw brush is disposed such that the brush bristles come into contact with an inner wall of the housing.

### SUMMARY

In an image forming apparatus using a so-called electrophotographic system, residual toner, which is toner remaining on an image holder without being transferred onto paper, is removed by a cleaning device. The toner removed from the image holder is transported by a toner transport device.

In this cleaning device, in general, the toner on the image holder is scraped off by a cleaning blade that comes into contact with the image holder, and the toner is removed from the image holder. In this case, in order to stably scrape off the toner with the cleaning blade, it is necessary to supply an external additive contained in the toner to a contact portion between the image holder and the cleaning blade. In a case of forming a high-density image in which a density of a toner image is high, sufficient residual toner is supplied to this contact portion, and the external additive is supplied. However, in a case where formation of a low-density image in which a density of a toner image is low continues, the residual toner is not sufficiently supplied to the contact portion. Therefore, a supply process of supplying the external additive to the contact portion through the supply of the toner while the low-density image is formed is required. This supply process interrupts the original image forming processing, and productivity of the image forming apparatus is decreased. In addition, this supply process consumes toner that is unnecessary for the original image formation.

Aspects of non-limiting embodiments of the present disclosure relate to an image forming apparatus that improves productivity and suppresses consumption of toner that is unnecessary for image formation, as compared with a case without a configuration in which toner removed from the image holder is supplied to the image holder.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including a cleaning blade that comes into contact with a surface of an image holder and removes toner adhering to the surface of the image holder, an accommodating member that accommodates the toner removed by the cleaning blade, and a supply unit that is disposed in the accommodating member and supplies the toner accommodated in the accommodating member to the surface of the image holder on an upstream side in a rotation direction of the image holder with respect to the cleaning blade.

### BRIEF DESCRIPTION OF THE DRAWINGS

Exemplary embodiment(s) of the present invention will be described in detail based on the following figures, wherein:

FIG. 1 is a diagram showing an example of an image forming apparatus;

FIG. 2 is an explanatory diagram for describing an image forming unit of the image forming apparatus;

FIG. 3 is an explanatory diagram for describing a function of a cleaning device;

FIG. 4 is a diagram showing an example of a transport member; and

FIG. 5 is an explanatory diagram for describing a function of a cleaning device in a modification example.

### DETAILED DESCRIPTION

Hereinafter, an exemplary embodiment of the present invention will be described in detail with reference to the accompanying drawings.

### Configuration of Image Forming Apparatus 1

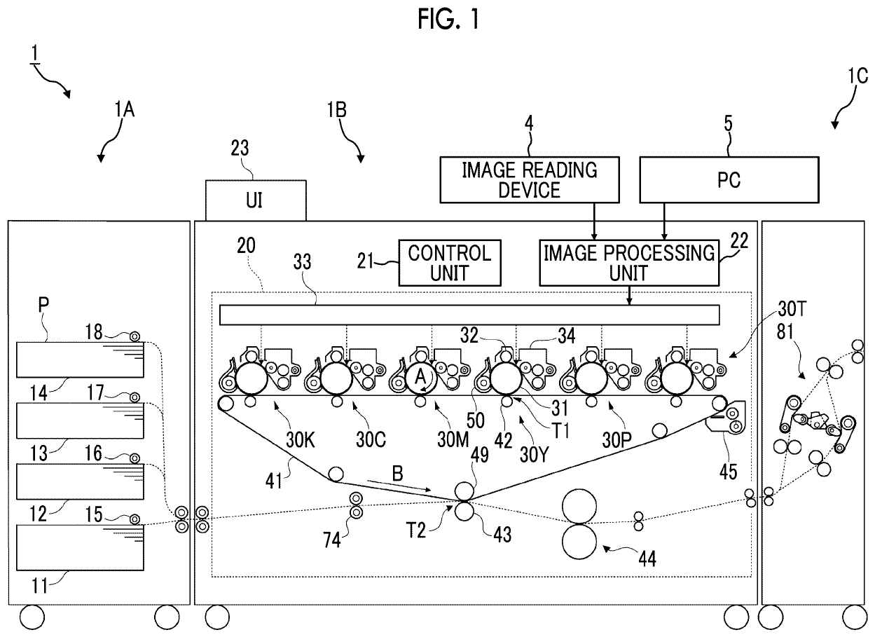

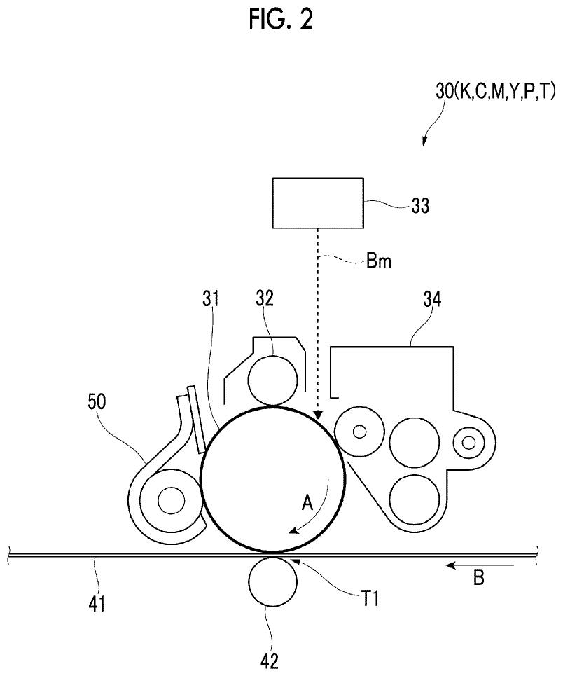

A configuration of an image forming apparatus 1 to which the present exemplary embodiment is applied will be described with reference to FIGS. 1 and 2.

FIG. 1 is a diagram showing an example of the image forming apparatus 1. In addition, FIG. 2 is an explanatory diagram for describing an image forming unit 30 of the image forming apparatus 1.

The image forming apparatus 1 according to the present exemplary embodiment includes a paper feed unit 1A that accommodates paper P as an example of a recording medium and that supplies the paper P. In addition, the image forming apparatus 1 includes a printing unit 1B that forms an image on the transported paper P. Further, the image forming apparatus 1 includes a paper discharge unit 1C that performs post-processing such as reversal on the paper P on which an image has been formed by the printing unit 1B and that discharges the paper P.

The paper feed unit 1A includes a first paper accommodation portion 11 to a fourth paper accommodation portion 14 that accommodate the paper P. In addition, in the paper feed unit 1A, feed rolls 15 to 18 are provided corresponding to the first paper accommodation portion 11 to the fourth paper accommodation portion 14, respectively. The feed rolls 15 to 18 feed the paper P accommodated in each paper accommodation portion to a transport path connected to the printing unit 1B.

The printing unit 1B includes an image forming portion 20, a control unit 21, an image processing unit 22, and a user interface (UI) 23.

The control unit 21 controls various operations such as an image reading operation and an image forming operation in the image forming apparatus 1. The image processing unit 22 performs image processing on image data transmitted from an image reading device 4 or a personal computer (PC) 5. The UI 23 is configured of a touch panel or the like, and notifies a user of information and receives an input of information from the user.

The image forming portion 20 includes six image forming units 30T, 30P, 30Y, 30M, 30C, and 30K (hereinafter, may be referred to as “image forming units 30”) disposed in parallel at regular intervals.

As shown in FIG. 2, each image forming unit 30 includes an image holder 31, a charging device 32, an exposure device 33, a developing device 34, and a cleaning device 50.

The image holder 31 uses charging characteristics and photosensitive characteristics to hold an image. The image holder 31 is a member having a cylindrical shape. As shown in FIG. 2, while the image holder 31 rotates in a direction of an arrow A, an electrostatic latent image is formed on a surface of the image holder 31 and is transferred onto the paper P. The charging device 32 charges the surface of the image holder 31. The exposure device 33 exposes the image holder 31 of each image forming unit 30 to light to form an electrostatic latent image.

The developing device 34 develops, using a developer, the electrostatic latent image formed on the image holder 31 by the exposure device 33. As this developer, a two-component developer having toner and carrier may be used, or a one-component developer containing no carrier may be used. The toner contains toner particles and an external additive. The external additive has a role of improving fluidity and chargeability of the toner, cleaning properties of the image holder 31, and the like.

The cleaning device 50 removes residual toner, which is toner remaining on the image holder 31 without being transferred onto the paper. Details of the cleaning device 50 will be described below.

The image forming units 30Y, 30M, 30C, and 30K form yellow (Y), magenta (M), cyan (C), and black (K) toner images, respectively. In addition, the image forming units 30T and 30P form a toner image using toner of special colors. Examples of the toner of special colors include toner corresponding to corporate colors, foamed toner for braille, fluorescent toner, and toner for improving glossiness.

In addition, the image forming portion 20 includes an intermediate transfer belt 41, a primary transfer roll 42, a secondary transfer roll 43, a fixing device 44, and a belt cleaner 45.

The toner image of each color formed on the image holder 31 of each image forming unit 30 is transferred onto the intermediate transfer belt 41. The primary transfer roll 42 transfers each color toner image of each image forming unit 30 onto the intermediate transfer belt 41 at a primary transfer portion T1. The secondary transfer roll 43 transfers the toner images transferred onto the intermediate transfer belt 41 all at once onto the paper P at a secondary transfer portion T2. The fixing device 44 fixes the second-transferred image onto the paper P. The belt cleaner 45 removes the toner or the like adhering to a surface of the intermediate transfer belt 41.

### Image Forming Operation

The image forming portion 20 performs an image forming operation based on a control signal from the control unit 21. Specifically, in the image forming portion 20, first, the image processing unit 22 performs image processing on the image data input from the image reading device 4 or the PC 5. The image data after the image processing is then supplied to the exposure device 33. For example, in the yellow (Y) image forming unit 30Y, the surface of the image holder 31 is charged by the charging device 32. Then, the exposure device 33 irradiates the image holder 31 with the laser light modulated by the image data obtained from the image processing unit 22. As a result, an electrostatic latent image is formed on the image holder 31.

The formed electrostatic latent image is developed by the developing device 34, and a yellow toner image is formed on the image holder 31. Similarly, magenta, cyan, and black toner images are formed in the image forming units 30M, 30C, and 30K. In addition, in the image forming units 30T and 30P, a special color toner image is formed.

Each color toner image formed in each image forming unit 30 is sequentially electrostatically transferred onto the intermediate transfer belt 41 that rotates in a direction of an arrow B in FIG. 1 by the primary transfer roll 42. As a result, toner images are formed on the intermediate transfer belt 41 in a superimposed manner.

The superimposed toner images formed on the intermediate transfer belt 41 are transported to the secondary transfer portion T2 configured with the secondary transfer roll 43 and a backup roll 49, as the intermediate transfer belt 41 is moved.

Meanwhile, for example, the paper P is taken out from the first paper accommodation portion 11 by the feed roll 15 and is then transported to a position of a register roll 74 through the transport path. In a case where the superimposed toner images are transported to the secondary transfer portion T2, the paper P is supplied from the register roll 74 to the secondary transfer portion T2 in accordance with a time of the transportation. At the secondary transfer portion T2, the superimposed toner images are electrostatically transferred all at once onto the paper P by the action of a transfer electric field formed between the secondary transfer roll 43 and the backup roll 49.

Then, the paper P onto which the superimposed toner images are electrostatically transferred is transported to the fixing device 44. In the fixing device 44, the paper P on which an unfixed toner image is formed is pressurized and heated, and fixing processing of the toner image on the paper P is performed. The paper P on which the fixing processing is performed passes through a curl correction portion 81 provided in the paper discharge unit 1C and is then transported to a paper stacking portion (not shown).

### Functions of Cleaning Device 50

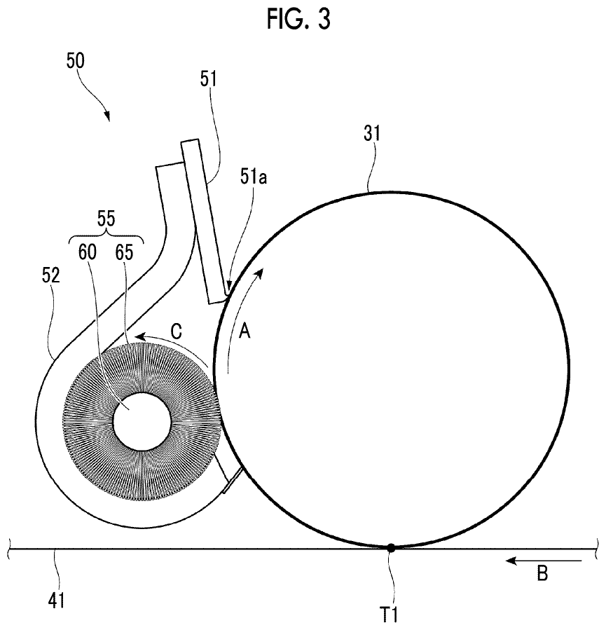

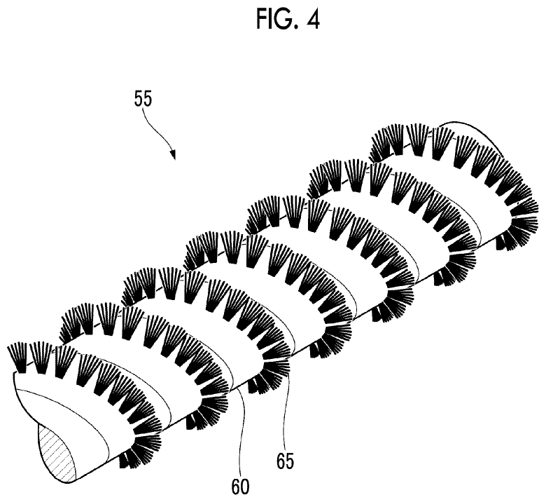

Next, functions of the cleaning device 50 in the present exemplary embodiment will be described with reference to FIGS. 3 and 4.

FIG. 3 is an explanatory diagram for describing the functions of the cleaning device 50. The cleaning device 50 is provided on a downstream side of the primary transfer portion T1 in a rotation direction of the image holder 31.

The cleaning device 50 includes a cleaning blade 51, an accommodating member 52, and a transport member 55. In the present exemplary embodiment, the transport member 55 functions as a supply unit that supplies toner accommodated in the accommodating member 52 to the image holder 31.

The cleaning blade 51 removes toner adhering to the surface of the image holder 31. The cleaning blade 51 has a flat plate shape extending along a rotation axis direction of the image holder 31 (a direction from the front to the back of a paper surface in FIG. 3). The cleaning blade 51 is formed of an elastic material such as polyurethane rubber. The cleaning blade 51 has an edge portion 51a that comes into contact with the surface of the image holder 31. The cleaning blade 51 in the present exemplary embodiment is disclosed such that the edge portion 51a faces a direction opposite to the rotation direction of the image holder 31. The edge portion 51a of the cleaning blade 51 is brought into contact with and is pressed against the image holder 31, thereby scraping off the residual toner on the image holder 31.

Here, in a case where the edge portion 51a of the cleaning blade 51 is largely worn, cleaning failure occurs, and the cleaning blade 51 reaches end of life without functioning as the cleaning blade 51. In order to extend the life, it is required to reduce the wear on the edge portion 51a. As a method of reducing the wear, a method of supplying toner containing an external additive to a contact portion between the cleaning blade 51 and the image holder 31 is considered. The external additive contained in the toner provides a lubricating action, and wear between the cleaning blade 51 and the image holder 31 is reduced. In the present exemplary embodiment, the toner in the accommodating member 52 is stably supplied to the image holder 31, and the toner is stably scraped off by the cleaning blade 51.

The accommodating member 52 is a member that accommodates the toner scraped off by the cleaning blade 51. The accommodating member 52 has a horizontally long container shape extending along the rotation axis direction of the image holder 31. In addition, an inner wall of the accommodating member 52 has a circular shape from a bottom portion to a side wall such that the transport member 55 comes into contact with the inner wall. In addition, a toner recovery bottle (not shown) as an example of a waste toner recovery portion is connected to one end portion of the accommodating member 52 in an axial direction. In addition, the transport member 55 that transports the toner to the toner recovery bottle is provided inside the accommodating member 52.

### Structure of Transport Member 55

FIG. 4 is a diagram showing an example of the transport member 55.

The transport member 55 in the present exemplary embodiment transports the toner accommodated in the accommodating member 52 to the toner recovery bottle, and supplies a part of the toner to the image holder 31. The transport member 55 includes a rotating body 60 having a rotation axis extending along the rotation axis direction of the image holder 31, and a brush 65 that has bristles radially extending from an axial surface of the rotating body 60. In addition, the brush 65 is spirally provided in the axial direction of the rotating body 60. The transport member 55 is rotationally driven by transmission of rotational power by a drive source (not shown) connected to one end portion of the rotating body 60 in the axial direction. The transport member 55 may be configured to rotate in response to the movement of the image holder 31.

A design example of the transport member 55 in the present exemplary embodiment will be shown below.

In the transport member 55 in the present exemplary embodiment, a diameter of the rotating body 60 can be, for example, about φ5 mm. In addition, the brushes 65 are provided at an interval of, for example, about 2 mm in a unit of a bundle of about 10 bristles having a diameter of, for example, 0.2 mm, and are spirally arranged around the rotating body 60. The bristles of the brush 65 may be made of, for example, polyacetal. In addition, a distance from the axial surface of the rotating body 60 to a tip of the brush 65 can be set to, for example, about 4.5 mm. In addition, the interval of the spiral of the brush 65 in the axial direction can be set to, for example, about 12 mm. According to the above-described design example, an outer diameter of the transport member 55 is φ14 mm.

Meanwhile, in the present exemplary embodiment, an inner diameter of the accommodating member 52 is set to, for example, φ13 mm, and the transport member 55 is disposed in the accommodating member 52 such that the tip of the brush 65 comes into contact with the surface of the image holder 31 and the inner wall of the accommodating member 52. In the case of the above-described design example, the transport member 55 is disposed at a position where the tip of the brush 65 penetrates the surface of the image holder 31 and the inner wall of the accommodating member 52 by 0.5 mm. This design example is merely an example, and the present exemplary embodiment is not limited to the above dimensions. In order to efficiently transport the toner in the accommodating member 52, for example, it is preferable that the tip of the brush 65 comes into contact with the surface of the image holder 31 and the inner wall of the accommodating member 52.

As shown in FIG. 3, the transport member 55 is provided on an upstream side in the rotation direction of the image holder 31 with respect to the cleaning blade 51. In addition, the transport member 55 is provided at a position where the tip of the brush 65 comes into contact with the surface of the image holder 31 and the inner wall of the accommodating member 52. The transport member 55 supplies the toner in the accommodating member 52 to the surface of the image holder 31 on the upstream side in the rotation direction of the image holder 31 with respect to the cleaning blade 51. In the present exemplary embodiment, the brush 65 has a hardness lower than a hardness of the image holder 31. This is to reduce wear on the image holder 31 in a case where the tip of the brush 65 comes into contact with the surface of the image holder 31.

### Cleaning Operation

In the image forming operation, the image holder 31 rotates in the direction of the arrow A as shown in FIG. 3. The toner (so-called residual toner) remaining on the image holder 31 without being transferred onto the paper at the primary transfer portion T1 is scraped off by the cleaning blade 51 and is accommodated in the accommodating member 52.

Meanwhile, the transport member 55 rotates in a direction of an arrow C in a state where the tip of the brush 65 is in contact with the surface of the image holder 31. In this case, the transport member 55 rotates while holding the toner accommodated in the accommodating member 52 on the brush 65. The transport member 55 supplies the toner held by the brush 65 to the surface of the image holder 31 at a contact portion where the tip of the brush 65 comes into contact with the surface of the image holder 31. As a result, the toner in the accommodating member 52 is stably supplied to the surface of the image holder 31. As the toner is supplied, the external additive is also supplied, and the cleaning of the cleaning blade 51 is stabilized.

In this case, in the present exemplary embodiment, the transport member 55 rotates in a state where the tip of the brush 65 is in contact with the inner wall of the accommodating member 52. Therefore, the toner adhering to the inner wall of the accommodating member 52 is scraped off by the brush 65 as the transport member 55 rotates. Then, the scraped toner is moved to the contact portion where the tip of the brush 65 comes into contact with the surface of the image holder 31 as the transport member 55 rotates, and is supplied to the surface of the image holder 31. As a result, the toner in the accommodating member 52 is stably supplied to the surface of the image holder 31 while preventing the toner from adhering to the accommodating member 52.

As shown in FIG. 3, in the present exemplary embodiment, the image holder 31 rotates in the direction of the arrow A, and the transport member 55 rotates in the direction of the arrow C. That is, at the contact portion between the tip of the brush 65 and the image holder 31, the transport member 55 rotates in the same direction as the rotation direction of the image holder 31. In this case, it is possible to gently bring the tip of the brush 65 into contact with the image holder 31 to promote the supply of the toner as compared with a case where the transport member 55 rotates in a direction different from the rotation direction of the image holder 31 at the contact portion.

In the present exemplary embodiment, a rotation speed of the transport member 55 is, for example, approximately equal to a rotation speed of the image holder 31. By making the rotation speed of the transport member 55 and the rotation speed of the image holder 31 approximately equal to each other, wear between the transport member 55 and the image holder 31 can be reduced. The rotation speed of the transport member 55 is not limited thereto. A manager or the like of the image forming apparatus 1 may determine the rotation speed of the transport member 55 or the rotation speed of the image holder 31 in advance while taking into consideration the transport capacity of the transport member 55 to the toner recovery bottle.

### Modification Example of Supply Unit

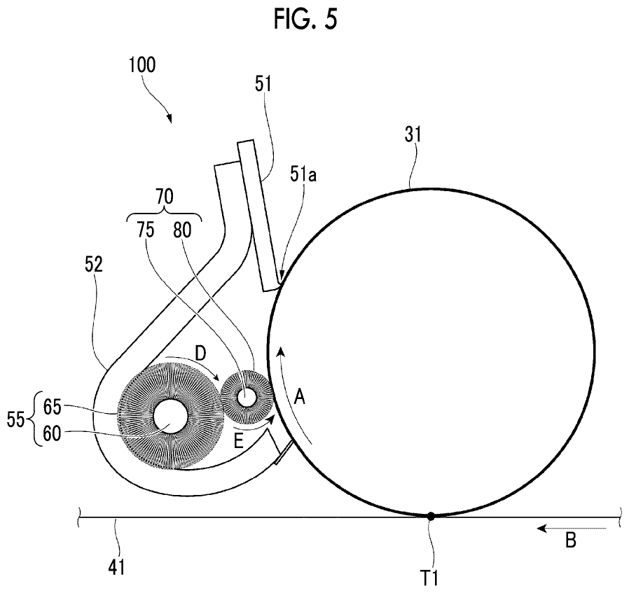

Next, a modification example of the supply unit will be described with reference to FIG. 5. FIG. 5 is an explanatory diagram for describing a function of a cleaning device 100 in the modification example.

In the above description, an aspect has been described in which the transport member 55 functions as a supply unit that supplies the toner to the image holder 31. In the modification example of the supply unit, the transport member 55 and the supply unit are separated from each other and are disposed in the accommodating member 52.

In FIG. 5, identical elements to the elements described in FIG. 3 are denoted by identical reference numerals, and the description thereof will be omitted.

The cleaning device 100 in the modification example shown in FIG. 5 includes a supply mechanism 70 in addition to the cleaning blade 51, the accommodating member 52, and the transport member 55. The supply mechanism 70 functions as a supply unit that supplies the toner to the image holder 31.

For example, the supply mechanism 70 may be configured with a second rotating body 75 having a rotation axis extending along the rotation axis direction of the image holder 31 and a second brush 80 that covers an outer peripheral surface of the rotating body.

Note that any shape can be adopted as long as the toner held by the transport member 55 can be transported to the image holder 31.

As shown in FIG. 5, the transport member 55 and the supply mechanism 70 are provided on the upstream side in the rotation direction of the image holder 31 with respect to the cleaning blade 51. The transport member 55 is disposed on an inner wall side of the accommodating member 52 such that the tip of the brush 65 comes into contact with the inner wall of the accommodating member 52. The supply mechanism 70 is disposed on the image holder 31 side in the accommodating member 52 compared to the transport member 55. In addition, the supply mechanism 70 is disposed at a position in contact with the surface of the image holder 31.

In the image forming operation, the image holder 31 rotates in the direction of the arrow A shown in FIG. 5. The residual toner remaining on the image holder 31 without being transferred onto the paper at the primary transfer portion T1 is scraped off by the cleaning blade 51 and is accommodated in the accommodating member 52.

Meanwhile, the transport member 55 rotates in a direction of an arrow D. Then, the transport member 55 transports the toner in the accommodating member 52 to the toner recovery bottle and delivers a part of the toner to the supply mechanism 70. The supply mechanism 70 rotates in a direction of an arrow E and supplies the toner delivered from the transport member 55 to the surface of the image holder 31 at a contact portion where a tip of the second brush 80 comes into contact with the surface of the image holder 31.

The supply mechanism 70 may be configured not to come into contact with the surface of the image holder 31 as long as the supply mechanism 70 can transport the toner in the accommodating member 52 to the image holder 31.

Although the exemplary embodiment of the present disclosure has been described, a technical scope of the present exemplary embodiment of the present disclosure is not limited to the exemplary embodiment. Various changes and substitutions of configurations that do not depart from the scope of the technical idea of the present disclosure are included in the present disclosure.

### Supplementary Note

(((1)))

An image forming apparatus comprising:
a cleaning blade that comes into contact with a surface of an image holder and removes toner adhering to the surface of the image holder;
an accommodating member that accommodates the toner removed by the cleaning blade; and
a supply unit that is disposed in the accommodating member and supplies the toner accommodated in the accommodating member to the surface of the image holder on an upstream side in a rotation direction of the image holder with respect to the cleaning blade.
   (((2)))

The image forming apparatus according to (((1))),
wherein the supply unit is a transport member that transports the toner accommodated in the accommodating member to a waste toner recovery portion.
   (((3)))

The image forming apparatus according to (((2))),
wherein the transport member includes a rotating body having a rotation axis, and a brush that is spirally provided in an axial direction of the rotating body and that has bristles radially extending from the rotating body, and
a tip of the brush comes into contact with the surface of the image holder.
   (((4)))

The image forming apparatus according to (((3))),
wherein the tip of the brush comes into contact with an inner wall of the accommodating member.
   (((5)))

The image forming apparatus according to (((3))) or ((4))),
wherein a hardness of the brush is lower than a hardness of the image holder.
   (((6)))

The image forming apparatus according to any one of (((1) to
wherein the supply unit is a transport member that is located on the upstream side in the rotation direction of the image holder with respect to the cleaning blade and that transports, by using a brush, the toner removed from the image holder by the cleaning blade.
   (((7)))

The image forming apparatus according to any one of (((3))) to (((6))),
wherein the tip of the brush of the transport member comes into contact with the image holder, and the transport member rotates in the same direction as the rotation direction of the image holder at a contact portion between the tip of the brush and the image holder.
   (((8)))

The image forming apparatus according to any one of (((1))) to (((7))),
wherein the supply unit rotates at a predetermined speed with respect to a rotation speed of the image holder and supplies the toner accommodated in the accommodating member.
   (((9)))

The image forming apparatus according to (((8))),
wherein the predetermined speed is the same as the rotation speed of the image holder.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a cleaning blade that comes into contact with a surface of an image holder and removes toner adhering to the surface of the image holder;
an accommodating member that accommodates the toner removed by the cleaning blade; and
a supply unit that is disposed in the accommodating member and supplies the toner accommodated in the accommodating member to the surface of the image holder on an upstream side in a rotation direction of the image holder with respect to the cleaning blade.

2. The image forming apparatus according to claim 1,
wherein the supply unit is a transport member that transports the toner accommodated in the accommodating member to a waste toner recovery portion.

3. The image forming apparatus according to claim 2,
wherein the transport member includes a rotating body having a rotation axis, and a brush that is spirally provided in an axial direction of the rotating body and that has bristles radially extending from the rotating body, and
a tip of the brush comes into contact with the surface of the image holder.

4. The image forming apparatus according to claim 3,
wherein the tip of the brush comes into contact with an inner wall of the accommodating member.

5. The image forming apparatus according to claim 3,
wherein a hardness of the brush is lower than a hardness of the image holder.

6. The image forming apparatus according to claim 1,
wherein the supply unit is a transport member that is located on the upstream side in the rotation direction of the image holder with respect to the cleaning blade and that transports, by using a brush, the toner removed from the image holder by the cleaning blade.

7. The image forming apparatus according to claim 6,
wherein the tip of the brush of the transport member comes into contact with the image holder, and the transport member rotates in the same direction as the rotation direction of the image holder at a contact portion between the tip of the brush and the image holder.

8. The image forming apparatus according to claim 7,
wherein the supply unit rotates at a predetermined speed with respect to a rotation speed of the image holder and supplies the toner accommodated in the accommodating member.

9. The image forming apparatus according to claim 8,
wherein the predetermined speed is the same as the rotation speed of the image holder.
